(19) United States
(12) Patent Application Publication
(10) Pub. No.: US 2026/0086033 A1
(43) Pub. Date: Mar. 26, 2026

(54) PRINTING APPARATUS, METHOD OF CONTROLLING THE SAME, AND STORAGE MEDIUM

(71) Applicant: CANON KABUSHIKI KAISHA, Tokyo (JP)

(72) Inventor: Ryohei Takahashi, Tokyo (JP)

(21) Appl. No.: 19/330,879

(22) Filed: Sep. 17, 2025

(30) Foreign Application Priority Data
Sep. 25, 2024 (JP) 2024-166560

(51) Int. Cl. G01N 21/55; B41J 11/00

(52) U.S. Cl. CPC G01N 21/55; B41J 11/009; B41J 11/0095; G01N 2021/555

(57) ABSTRACT

A printing apparatus comprises a photodetector including a plurality of light-receiving devices, apertures through which specular reflection light and diffused reflection light, which are light from a light-emitting unit reflected by a target, pass into the photodetector, a selector configured to select at least one light-receiving device among the plurality of light-receiving devices, and an amplifier configured to amplify a signal from a light-receiving device of the photodetector. The printing apparatus performs control so as to select light-receiving devices by the selector and switch connection between the light-receiving devices selected by the selector and the amplifier, in accordance with a detection mode for detecting the target.

### BACKGROUND

### Field of the Technology

The present disclosure relates to a printing apparatus, a method of controlling the same, and a storage medium.

### Description of the Related Art

In conventional inkjet printing apparatuses, sensors for detection and measurement have been mounted for various purposes, such as improving quality of printed image, improving accuracy, and improving convenience of users. These sensors are used to realize various detection functions, and for example, there are sensors for detecting the width of recording paper set in the printing apparatus and an edge of recording paper and for measuring the densities of patches (patterns) and images recorded on recording paper. Further, there are sensors for detecting the thickness of recording paper and the presence or absence of recording paper, sensors for determining the type of recording paper, and the like. Japanese U.S. Pat. No. 4,757,136 describes a printing apparatus in which a plurality of detection functions for recording are realized using optical sensors.

In order to provide a plurality of detection functions as described above in a printing apparatus, it is necessary to mount a sensor for each detection function, and there is a problem that an increase in the number of detection functions leads to an increase in the cost and size of the printing apparatus. Further, when an attempt is made to realize a plurality of detection functions with one sensor, there is a problem that, even if the sensor is an optimum sensor for a certain detection function, the detection accuracy decreases in other detection functions.

### SUMMARY

Embodiments of the present disclosure eliminate the above-mentioned issues with conventional technology.

A feature of embodiments of the present disclosure is to provide a technique for realizing a plurality of detection functions with a smaller number of light-receiving devices by switching light-receiving devices used for detection in accordance with a detection mode.

According to embodiments of the present disclosure, there is provided a printing apparatus comprising: a photodetector including a plurality of light-receiving devices; apertures through which specular reflection light and diffused reflection light, which are light from a light-emitting unit reflected by a target, pass into the photodetector; a selector configured to select at least one light-receiving device among the plurality of light-receiving devices; an amplifier configured to amplify a signal from a light-receiving device of the photodetector; and one or more controllers including one or more processors and one or more memories, wherein the one or more controllers are configured to: in accordance with a detection mode for detecting the target, perform control so as to select light-receiving devices by the selector and switch connection between the light-receiving devices selected by the selector and the amplifier.

According to embodiments of the present disclosure, there is provided a method of controlling a printing apparatus including a photodetector including a plurality of light-receiving devices, apertures through which specular reflection light and diffused reflection light, which are light from a light-emitting unit reflected by a target, pass into the photodetector, and an amplifier configured to amplify a signal from a light-receiving device of the photodetector, the method comprising: selecting at least one light-receiving device among the plurality of light-receiving devices; in accordance with a detection mode for detecting the target, perform control so as to select light-receiving devices by the selector and switch connection between the light-receiving devices selected by the selector and the amplifier; and executing processing for detecting the target corresponding to the detection mode, based on a signal obtained by the amplifier amplifying signals from the selected light-receiving devices.

Further features of the various embodiments will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram for describing a configuration of an inkjet printing apparatus according to a first embodiment of the present disclosure.

FIG. 2 is a schematic diagram illustrating a configuration of a carriage unit mounted on a carriage of the inkjet printing apparatus according to the first embodiment of the present disclosure.

FIG. 3A depicts a plan view of a light-receiving device array according to the first embodiment.

FIG. 3B depicts a side view of an optical sensor (light-receiving device array), a light-emitting device, and a sensor unit.

FIG. 4 is a block diagram for describing a configuration of the sensor unit according to the first embodiment.

FIG. 5 is a flowchart for explaining processing for obtaining a detection result in the inkjet printing apparatus according to the first embodiment.

FIG. 6 is a diagram illustrating an example of a table indicating an example of selection of light-receiving devices by a selector and connection between current-voltage converters and light-receiving devices, corresponding to detection modes.

FIG. 7 is a diagram for describing an example of connection between the light-receiving device array of the sensor unit, the selector, and a differential amplifier according to the first embodiment.

FIGS. 8A to 8C are diagrams illustrating an example of settings in detection mode 1.

FIGS. 9A and 9B are diagrams illustrating a change in an output waveform for detecting an edge of recording paper by selecting light-receiving devices PD 40 and PD 50 in the first embodiment.

FIGS. 10A and 10B are diagrams illustrating an example of selection of light-receiving devices when the detection mode is for detecting paper type.

FIG. 11 is a flowchart for explaining processing for detecting an edge of recording paper in the inkjet printing apparatus according to a second embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

First, the terms used in the present embodiment will be defined in advance as follows.

### “Recording (Printing)”

In this specification, “recording (printing)” is not only forming significant information such as letters, shapes, and the like. The significance or insignificance is irrelevant, as is whether visual perception by humans is possible. It refers to forming images, designs, patterns, and the like broadly on a recording medium, as well as processing the medium.

### “Recording Media”

Recording media refers not only to paper used in general printing apparatuses, but also broadly to those that can receive ink, such as cloth, plastic films, metal plates, glass, ceramics, wood, and leather.

### “Ink”

Ink is to be interpreted broadly, similar to the definition of “recording (printing)” above, and refers to a medium that includes a recording agent which, by being applied to a recording medium, forms images, designs, patterns, and the like, or which may be supplied in processing of a recording medium, or processing of ink. In terms of physical properties, it is a liquid. The above ink processing is, for example, coagulation or insolubilization of a colorant in an ink applied to a recording medium.

### “Nozzle”

Unless otherwise specified, “nozzle” refers to a discharge port. Inside the nozzle, there are communicating liquid paths and an element that generates energy used for ink discharge.

### “Scanning”

In order to perform recording on a recording medium, a print head scans over the recording medium and performs recording. Here, the movement of the head during acceleration and deceleration of the head for or related to recording is referred to as scanning.

### “Bi-Directional Recording”

Bi-directional recording refers to performing recording while performing a bi-directional operation of the above “recording” or “scanning” over the paper surface. Bi-directional scanning, bi-directional recording, two-way scanning, and two-way recording also refer to similar things.

### First Embodiment

A first embodiment of the present disclosure will be described with reference to the drawings.

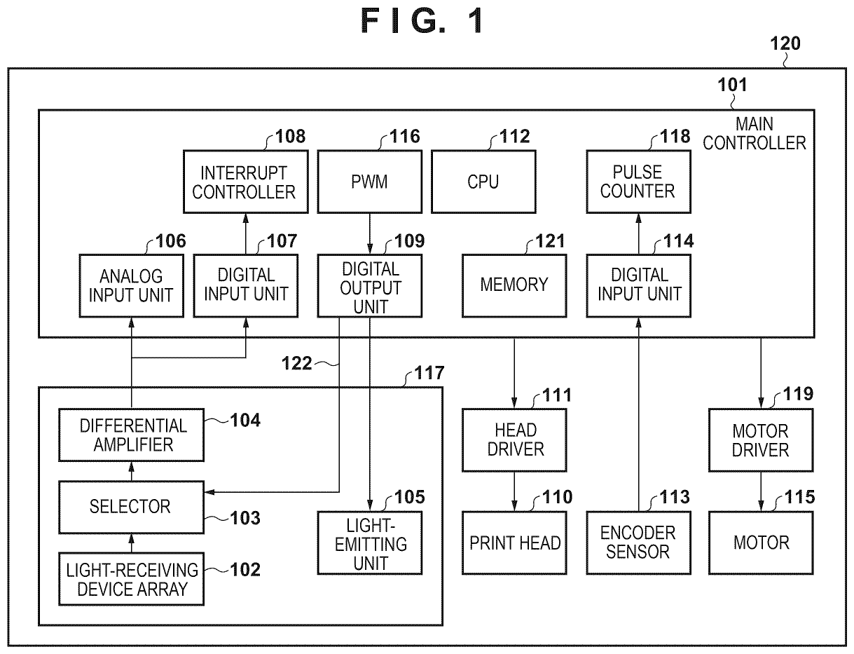

FIG. 1 is a block diagram for describing a configuration of an inkjet printing apparatus 120 according to the first embodiment of the present disclosure.

A sensor unit 117 includes a light-emitting unit (light-emitting device) 105 and a light-receiving device array (sensor array) 102, and signals outputted from the light-receiving device array 102 are outputted to a differential amplifier (differential amplification unit) 104 via a selector 103. The differential amplifier 104 can amplify or differentially amplify the signals from the selected light-receiving devices (light-receiving sensors) in the light-receiving device array 102 according to the settings of the selector 103, and sends the amplified signal to a main controller 101. An example of a circuit of the sensor unit 117 will be described later with reference to FIG. 4.

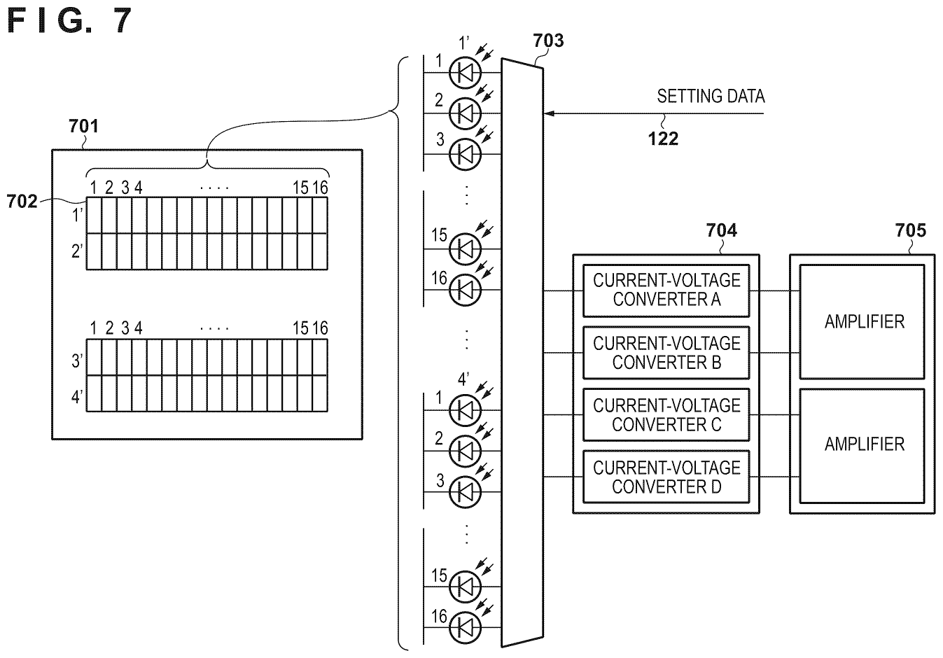

The main controller 101 switches the selection of light-receiving devices of the light-receiving device array 102 by the selector 103, the connection between the selected light-receiving devices and the differential amplifier 104, and the like in accordance with setting data 122. This configuration will be described later with reference to FIG. 7. Further, the main controller 101 receives the signal from the differential amplifier 104 at an analog input unit 106 and a digital input unit 107. Further, the digital input unit 107 is connected to an interrupt controller 108 in the main controller 101, and the interrupt controller 108 issues an interrupt signal to a CPU 112 according to a predetermined interrupt condition. The CPU 112 controls the operation of the inkjet printing apparatus 120 in accordance with a program stored in a memory 121. The memory 121 includes a ROM and a RAM. Upon receiving the interrupt signal, the CPU 112 executes the processing related to the interrupt signal with priority over the processing being performed, and can thus handle the signal inputted to the digital input unit 107 more immediately. Further, the light-emitting device 105 is driven by a pulse width modulation signal, which is outputted from a pulse width modulation (PWM) unit 116 in the main controller 101 via a digital output unit 109, and its light emission amount is controlled by the pulse width modulation signal.

A print head 110 is driven via a head driver 111 according to an image signal to be recorded. Further, the print head 110 scans over the recording medium by being driven by a motor 115 via a motor driver 119. A scanning position of the print head 110 is detected based on a signal from an encoder sensor 113, which is inputted to a digital input unit 114, and that scanning position is managed by a pulse counter 118 in the main controller 101 that inputs the signal from the encoder sensor 113.

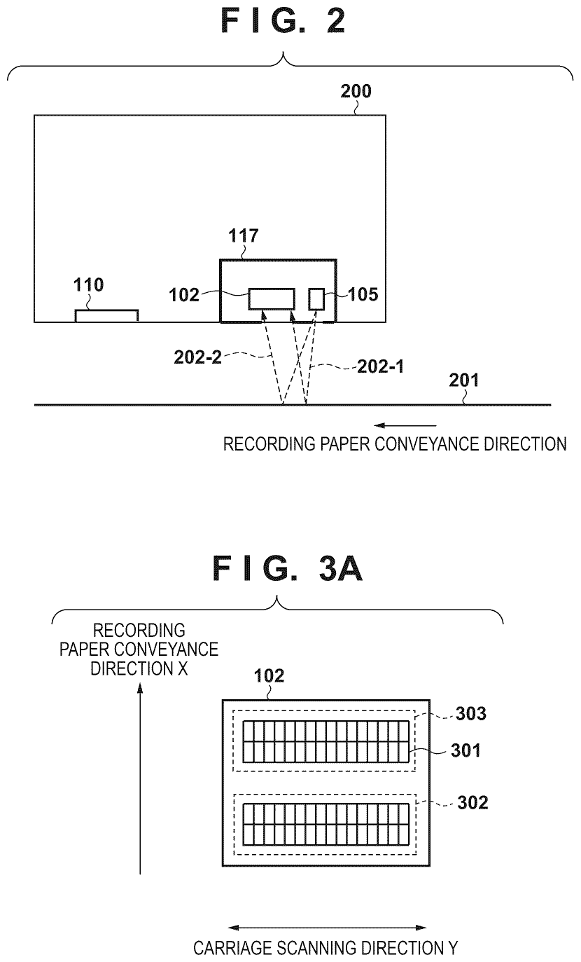

FIG. 2 is a schematic diagram illustrating a configuration of a carriage unit 200 mounted on a carriage of the inkjet printing apparatus according to the first embodiment of the present disclosure.

The sensor unit 117 (including the light-receiving device array 102 (including a plurality of light-receiving devices) and the light-emitting device 105 (e.g., LED)), the print head 110, and the like are included in the carriage unit 200, which stores ink cartridges.

Light 202-1 irradiated from the light-emitting device 105 irradiates recording paper 201, which is an inspection target, through an opening (aperture) arranged in the sensor unit 117, and reflected light 202-2 is received by the light-receiving device array 102 through another opening (aperture).

The recording paper 201 is fed from a feeding tray or a feeding cassette at the time of printing and conveyed in an arrow direction. An image is formed on the recording paper 201 by driving the print head 110 in synchronization with scanning of the carriage unit 200.

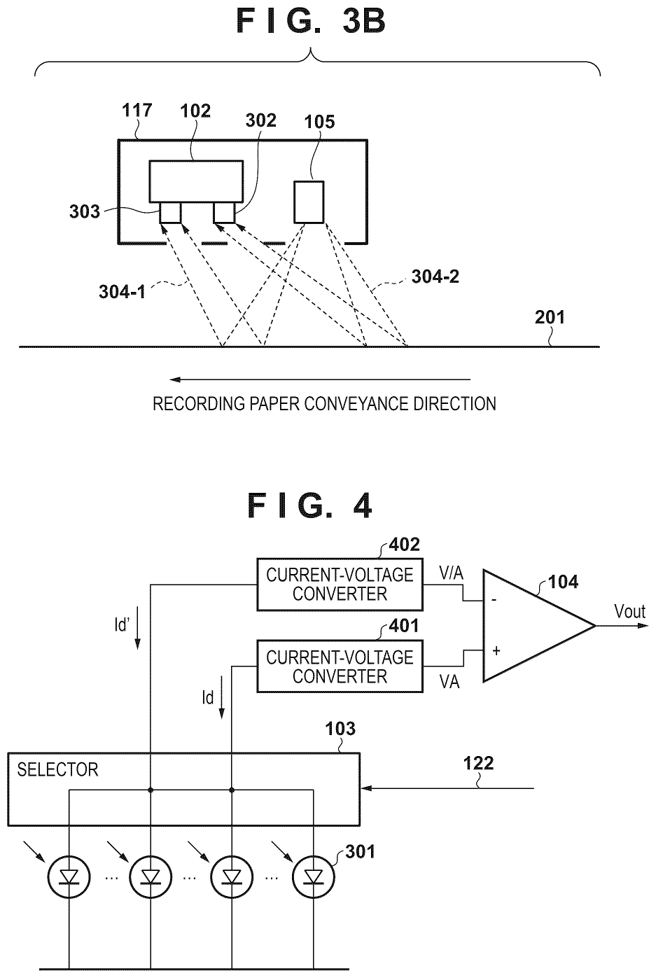

FIG. 3A depicts a plan view of the light-receiving device array 102 according to the first embodiment. FIG. 3B depicts a side view of the optical sensor (light-receiving device array) 102, the light-emitting device 105, and the sensor unit 117.

The light-receiving device array 102 includes a total of 64 light-receiving devices (photodiodes) in four rows of photodiode arrays, each row with 16 light-receiving devices 301 arranged in a scanning direction of the carriage unit 200. Further, the photodiode arrays are arranged in a manner in which they are divided into two areas: a light-receiving area 302 and a light-receiving area 303.

The light-receiving area 302 receives only diffused reflection light 304-2, which is light irradiated from the light-emitting device 105 guided by the opening (aperture) provided in the sensor unit 117 and reflected by the paper surface of the recording paper 201. Further, the light-receiving area 303 receives only specular reflection light 304-1, which is light irradiated from the light-emitting device 105 guided by the opening (aperture) provided in the sensor unit 117 and reflected by the paper surface of the recording paper 201.

FIG. 4 is a block diagram for describing a configuration of the sensor unit 117 according to the first embodiment.

The light-receiving devices 301 are connected to the selector 103, and the selector 103 can select light-receiving devices 301 to be connected to a current-voltage converter (photoelectric converter) 401 and a current-voltage converter 402 in accordance with the setting data 122. Photocurrents Id and Id′ flow when the selected light-receiving devices receive light reflected by the recording paper 201. The photocurrent Id is converted into a voltage value VA of the positive electrode by the current-voltage converter 401, and the photocurrent Id′ is converted into a voltage value V/A of the negative electrode by the current-voltage converter 402. The voltage values VA and V/A converted by the current-voltage converters 401 and 402 are inputted into the differential amplifier 104, and a recording paper position detection signal Vout is outputted.

With the above configuration, the main controller 101 can select light-receiving devices to be used for position detection from among 64 arranged light-receiving devices 301 by switching the setting of the selector 103 in accordance with the setting data 122. At the same time, as described with reference to FIG. 3A, since an area of light-receiving devices into which specular reflection light enters and an area of light-receiving devices into which diffused reflection light enters are separated by apertures, whether to use the specular reflection light or the diffused reflection light can also be selected.

Further, by selecting the light-receiving devices to be connected to the current-voltage converter 401 and the current-voltage converter 402 by the selector 103, it is possible to select whether to use the amplification by the differential amplifier 104 as single amplification of the VA signal or the V/A signal. Further, it is possible to select by the selector 103 whether to use the amplification by the differential amplifier 104 as differential amplification by the VA signal and the V/A signal. For example, when performing single amplification on only the VA signal, by not connecting a light-receiving device to the current-voltage converter 402 (the voltage value of the V/A signal is 0V), it is possible to output only the VA signal as a signal that has been amplified in accordance with the gain of the differential amplifier 104.

With the configuration as described above, it is possible to select light-receiving devices in the light-receiving device array 102 so as to be optimal for the detection mode of the detection target and perform detection.

Next, a method of obtaining various parameters by using the light-receiving device array 102 in accordance with the detection mode will be described.

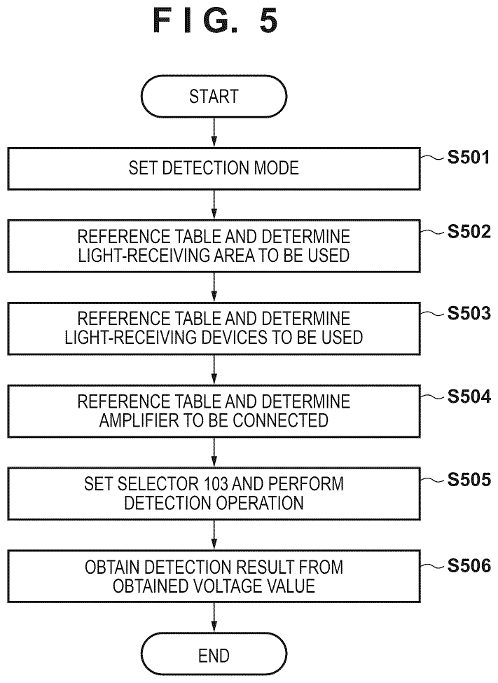

FIG. 5 is a flowchart for explaining processing for obtaining a detection result in the inkjet printing apparatus 120 according to the first embodiment. The processing described in this flowchart is realized by the CPU 112 executing a program deployed to the memory 121. In this flowchart, the description of control for conveying the recording paper is omitted.

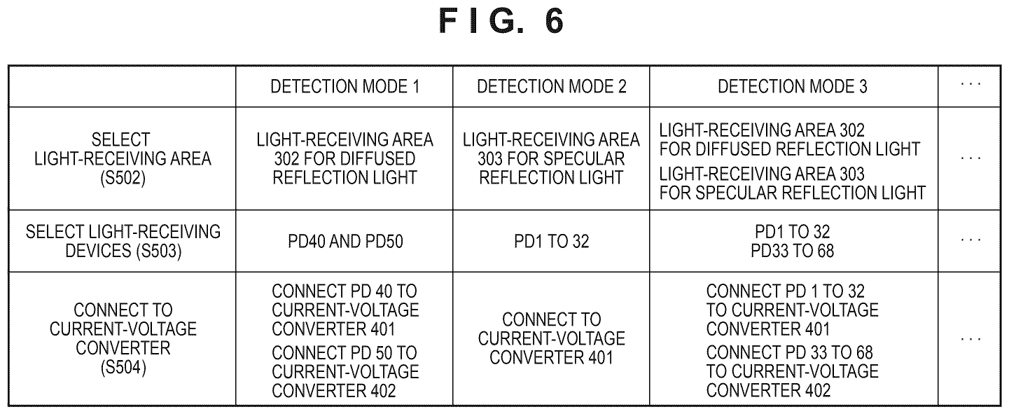

FIG. 6 is a diagram illustrating an example of a table indicating an example of selection of light-receiving devices by the selector 103 and connection between current-voltage converters and light-receiving devices, corresponding to detection modes.

The processing indicated in the flowchart of FIG. 5 is started, for example, by the inkjet printing apparatus 120 starting a detection operation, and first, in step S501, the CPU 112 sets a detection mode in accordance with a target to be detected. Detection modes include, for example, a detection mode for detecting an edge of recording paper, a detection mode for detecting the type of recording paper, and the like. When a detection mode is thus set, in steps S502 to S504, the CPU 112 references a table (FIG. 6) stored in the memory 121 and determines various settings for switching by the selector 103 corresponding to the detection mode. First, in step S502, the CPU 112 determines whether the area of light-receiving devices to be used in the light-receiving device array 102 is the light-receiving area 303 for receiving specular reflection light or the light-receiving area 302 for receiving diffused reflection light. Next, the processing proceeds to step S503, and the CPU 112 references the table (FIG. 6) and determines light-receiving devices to be used in the light-receiving device array 102 in accordance with the detection mode. Next, the processing proceeds to step S504, and the CPU 112 references the table (FIG. 6) and determines connection between the selected light-receiving devices and the current-voltage converters in accordance with the detection mode. Next, the processing proceeds to step S505, and the CPU 112 creates setting data 122 based on the matters determined in steps S502 to step S504, outputs it to the selector 103, and sets the selector 103. When the setting of the selector 103 is thus completed, a voltage value is obtained by executing a detection operation in which the selected light-receiving devices 301 are used. Then, in step S506, the CPU 112 obtains a detection result such as the edge position, the paper type, and the like of the recording paper based on the obtained voltage value and terminates the detection operation.

FIG. 7 is a diagram for describing an example of connection between the light-receiving device array of the sensor unit 117, the selector, and the differential amplifier according to the first embodiment.

A light-receiving device array 701, which comprises a plurality of sensors and corresponds to the light-receiving device array 102, is arranged in the sensor unit 117. FIG. 7 illustrates a sensor unit that includes a total of 64 sensors, with light-receiving devices 702, which correspond to the above light-receiving devices 301, in a 16×4-row arrangement. Each light-receiving device 702 is connected to a selector 703 in the sensor unit 117. The selector 703 corresponds to the selector 103 of FIG. 1. Light-receiving devices 702 to be used to detect a medium edge position can be arbitrarily selected from the light-receiving device array 701 according to the settings based on the setting data 122 inputted to the selector 703. Further, the outputs of a plurality of light-receiving devices 702 can be outputted in a bundle in accordance with the settings of the selector 703, and the number of light-receiving devices 702 to be bundled and the positions of the light-receiving devices 702 can also be arbitrarily selected. For example, the outputs of 16 light-receiving devices from the first to 16th ones of the third row can be connected to the selector 703 in a bundle as a photodetector, or the outputs of odd-numbered light-receiving devices, such as the first, third, fifth, and seventh ones of the first row, can be selected as the photodetector. Furthermore, the photodetector can be selected with arbitrary positions and number of light-receiving devices to be selected, such as selecting the outputs of the first light-receiving device 702 of each row from 1′ to 4′ as the photodetector. By thus allowing selection of a plurality of bundled light-receiving devices 702 as the photodetector, it is possible to artificially increase the surface area of the photodetector, allowing realization of an increase in sensitivity of the photodetector, for example. The settings of the selector 703 can be set by an instruction from the CPU 112 as described above, and selection of light-receiving devices, connection between the light-receiving devices and the current-voltage converter, and the like, which will be described later, are performed by cooperation of the CPU 112 and the selector 103.

The outputs of the selector 703 are connected to current-voltage converters A to D arranged in a current-voltage converter 704 in the sensor unit 117. The current-voltage converter 704 includes the current-voltage converters 401 and 402 of FIG. 4. This makes it possible to arbitrarily select by the selector 703 which current-voltage converter to connect the output of a light-receiving device 702 or a plurality of light-receiving devices 702 to. The outputs of the current-voltage converter 704 are connected to an amplifier unit 705, and an amplified output can be obtained from the amplifier unit 705. The amplifier unit 705 corresponds to the differential amplifier 104 of FIG. 1. The amplifier unit 705 includes a coarse adjustment amplifier, a fine adjustment amplifier, a differential amplifier, and the like, and which amplifier to use can be arbitrarily selected, and a combination of respective amplifiers can be arbitrarily selected. However, the configuration of the amplifier unit 705 is not limited to only what has been described above, such as arranging one type of amplifier or arranging more types of amplifiers, in addition to the case where a plurality of amplifiers are arranged in the amplifier unit 705.

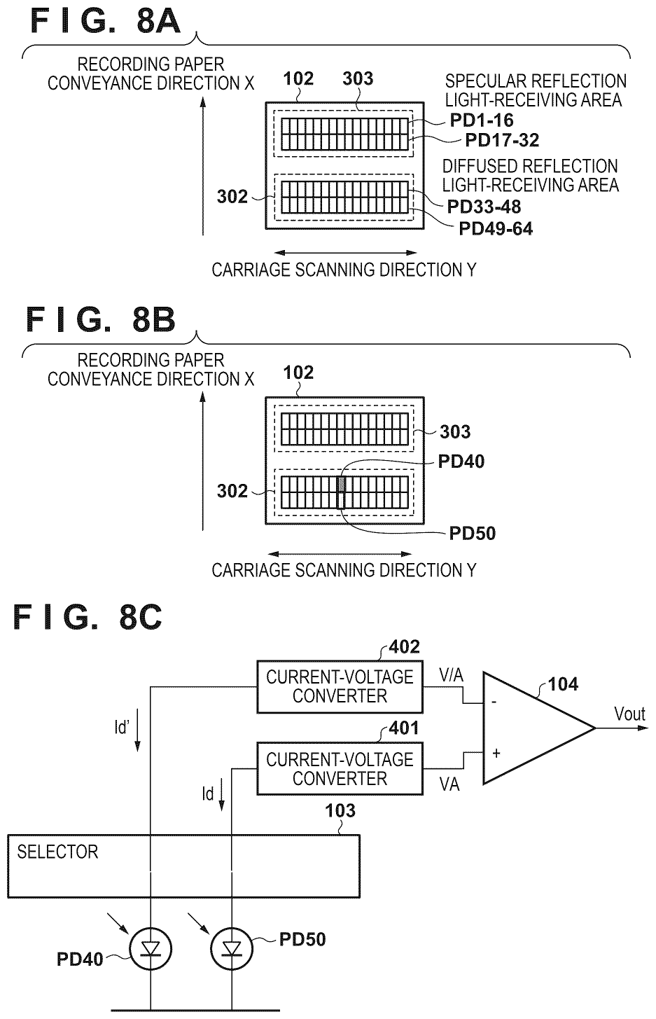

FIGS. 8A and 8B are diagrams illustrating an example of settings in detection mode 1.

FIG. 8A is a diagram illustrating assignment of numbers to the light-receiving devices, and FIG. 8B is a diagram illustrating an example of settings for the selector 103 in detection mode 1. Here, as an example of the detection mode, a method of performing recording paper edge detection in which the light-receiving device array 102 is used will be described.

Regarding settings for the selector 103 in edge detection mode (detection mode 1), when the table of FIG. 6 is referenced, the light-receiving area is the light-receiving area 302 for receiving diffused reflection light (step S502). Then, the selected light-receiving devices are light-receiving devices PD 40 and PD 50 as illustrated in FIG. 8B (step S503). Here, in order to detect the edges of the leading and trailing edges of the recording paper, the light-receiving devices PD 40 and PD 50, which are positioned in the front and rear relative to the conveyance direction of the recording paper are selected. Then, it is determined to connect the light-receiving device PD 50 to the current-voltage converter 401 and connect the light-receiving device PD 40 to the current-voltage converter 402 in accordance with the table of FIG. 6 (step S504).

By outputting the setting data 122 in accordance with the settings for the selector 103 thus determined, it is possible to connect the selected light-receiving devices PD 40 and PD 50 and the current-voltage converters 401 and 402, as illustrated in FIG. 8C, for example.

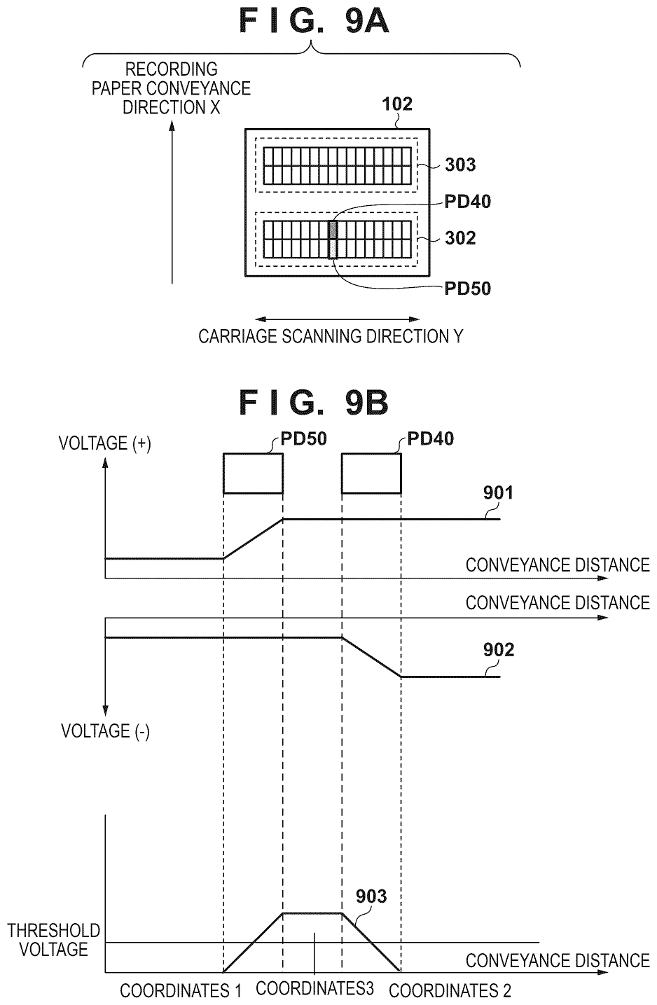

FIGS. 9A and 9B are diagrams for describing a change in an output waveform for detecting an edge of recording paper by selecting light-receiving devices PD 40 and PD 50 in the first embodiment.

The recording paper is conveyed, and when light reflected from the recording paper enters the selected light-receiving device PD 50 in the light-receiving device array 102, the photocurrent Id starts to flow. Thus, a waveform 901 of the output voltage VA of the current-voltage converter 401 gradually rises, and when the leading edge of the recording paper passes the light-receiving device PD 50, the waveform 901 of the voltage VA maintains the peak voltage of the positive electrode.

The recording paper is further transported, and when light reflected from the recording paper enters the other light-receiving device PD 40, the photocurrent Id′ starts to flow, and a waveform 902 of the output voltage V/A of the current-voltage converter 402 gradually drops, then when the leading end of the recording paper passes the light-receiving device PD 40, the waveform 902 of the voltage V/A maintains the peak voltage of the negative electrode.

The VA voltage waveform 901 and the V/A voltage waveform 902 are inputted to the differential amplifier 104, and a signal Vout waveform 903, which has been differentially amplified, is outputted.

From the obtained waveform 903, center coordinates 3 are calculated from the values of coordinates 1 and coordinates 2, where the voltage value is a threshold. Since the center coordinates are the coordinates of the leading edge of the recording paper, the leading edge of the recording paper can thus be detected.

As described above, by detecting an edge of the recording paper based on a voltage value obtained by differential amplification of outputs from a plurality of light-receiving devices, it is possible to cancel changes in detection voltage caused by changes in the environment, compared to detection in which one light-receiving device is used. This makes it possible to detect a paper edge with higher accuracy.

Next, detection of the paper type of the recording paper in which the above light-receiving device array 102 is used will be described as an example of detection mode 3.

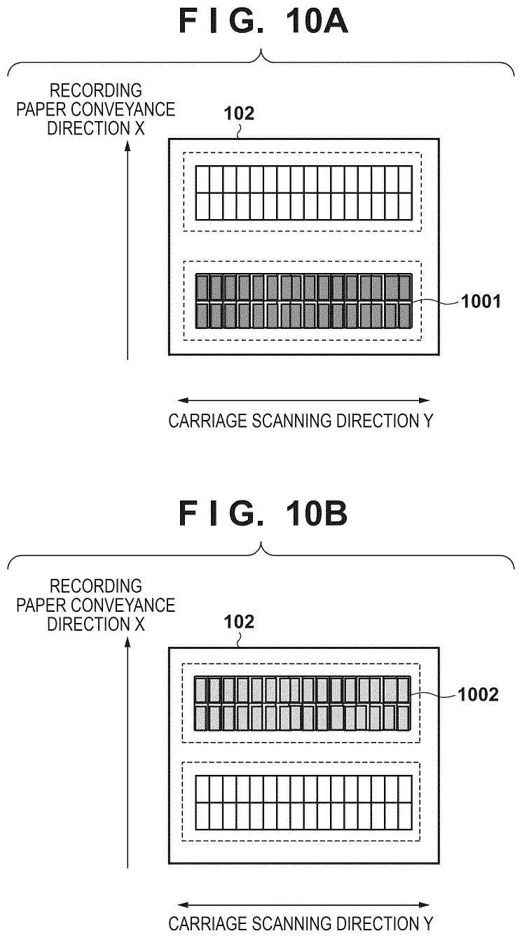

FIGS. 10A and 10B are diagrams illustrating an example of selection of light-receiving devices when the detection mode is for detecting paper type.

FIG. 10A illustrates an example in which all the light-receiving devices of a diffused reflection light incident area 1001 are selected and are connected to the current-voltage converter 401 for single amplification in a paper type detection mode. Further, FIG. 10B illustrates a setting example in which all the light-receiving devices of a specular reflection light incident area 1002 are selected and are connected to the current-voltage converter 402 for single amplification.

The reflection characteristics of the recording paper generally differ for each type of paper, and recording paper with a high surface smoothness, such as glossy paper, for example, has a characteristic that a specular reflection light amount is large and a diffused reflection light amount is small. Conversely, recording paper with a low smoothness has a characteristic that a specular reflection light amount is small and a diffused reflection light amount is large.

When the recording paper 201 is conveyed to just below the light-receiving device array 102, an output voltage value based on diffused reflection light and an output voltage value based on specular reflection light are obtained while switching the light-receiving device group to be selected by the selector 103 as illustrated in FIGS. 10A and 10B. With this, the light amount of diffused reflection light and the light amount of specular reflection light are obtained. By storing a table in which the type of recording paper is associated with the amount of specular reflection light or the amount of diffused reflection light received by the light-receiving devices when light is irradiated on the recording paper in a memory, it is possible to detect the type of recording paper based on the light amount.

In the above examples of detection modes, operations for detecting a sheet edge of recording paper and for detecting the type of recording paper are described. However, the present disclosure is not limited to a form in which these detection operations are executed and need only be in a form in which at least two detection operations are executed. For example, detection of a distance between a sensor and recording paper and detection of registration adjustment and the like by detection of densities of color patches are also included in the scope of the present disclosure.

As described above, according to the first embodiment, by switching the light-receiving devices to be used and the connection between the light-receiving devices and the amplifier in accordance with the detection mode, it is possible to reduce changes in detection voltage caused by changes in the environment or the like, compared to performing detection in which light-receiving devices are used in a fixed manner. This makes it possible to detect a paper edge with higher accuracy.

### Second Embodiment

Next, a second embodiment of the present disclosure will be described. Since the hardware configuration and the like of the inkjet printing apparatus 120 according to the second embodiment are the same as those of the above first embodiment, the description thereof will be omitted.

In the second embodiment, a combination of the above recording paper edge detection mode and recording paper type detection mode will be described as an example.

In the case of the recording paper edge detection mode in which the above differential amplification is used, in order to extend the life of the light-receiving devices, it is desirable to use less light-receiving devices (reduce the current). However, when detecting an edge of the recording paper with a low reflectance, if the number of the light-receiving devices to be used is small, the detection voltage becomes small and thus may not exceed a detection threshold voltage. Therefore, it is desirable to select a minimum number of light-receiving devices that exceeds the detection threshold voltage.

Therefore, first, the type of recording paper is determined in the paper type detection mode. By storing a table in which the type of recording paper is associated with a minimum number of light-receiving devices that exceeds the detection threshold voltage in a memory, it is possible to optimally set the number of the light-receiving devices to be selected in the edge detection mode in accordance with the determined type of recording paper. By thus selecting an optimum number of light-receiving devices in accordance with the paper type of the recording paper detected in advance, it is possible to detect an edge of the recording paper.

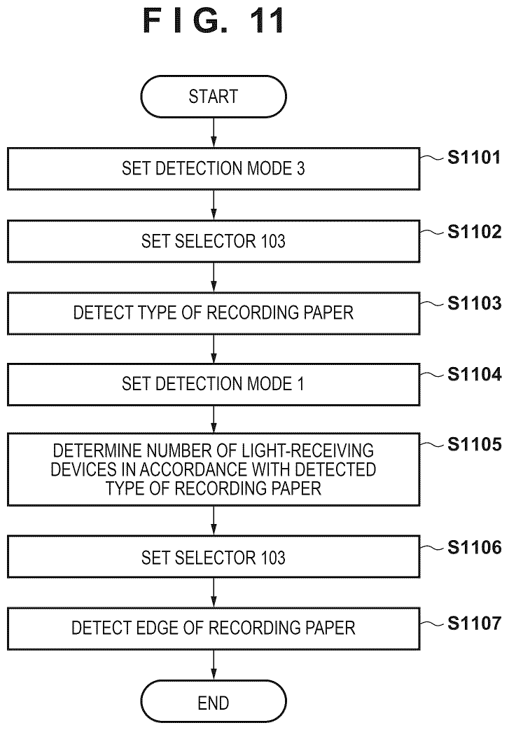

FIG. 11 is a flowchart for explaining processing for detecting an edge of recording paper in the inkjet printing apparatus 120 according to the second embodiment. The processing described in this flowchart is realized by the CPU 112 executing a program deployed to the memory 121. In this flowchart, the description of control for conveying the recording paper is omitted.

In step S1101, the CPU 112 sets detection mode 3 to determine the type of the recording paper. Next, the processing proceeds to step S1102, and the CPU 112 references the table of FIG. 6 and sets the selector 103 so as to select the specular reflection light-receiving area and the diffused reflection light-receiving area in accordance with detection mode 3, connect the specular reflection light-receiving area PD 1 to PD 32 to the current-voltage converter 401, and connect the diffused reflection light-receiving area PD 33 to PD 68 to the current-voltage converter 402. Then, the processing proceeds to step S1103, and the CPU 112 determines the type of the recording paper based on the light reflected from the recording paper.

Next, the processing proceeds to step S1104, and the CPU 112 sets detection mode 1 to detect an edge of the recording paper. Next, the processing proceeds to step S1105, and the CPU 112 determines the number of the light-receiving devices to be selected corresponding to the type of the recording paper determined in step S1103. As described above, this is obtained by referencing the table in which the type of recording paper and a number of necessary light-receiving devices are associated. Then, the processing proceeds to step S1106, and the CPU 112 sets the selector 103 to select the number of light-receiving devices determined in step S1105 in the diffused reflection light-receiving area. Then, the processing proceeds to step S1107, and the CPU 112 detects an edge of the recording paper as described with reference to FIGS. 8A and 8B.

As described above, according to the second embodiment, by employing information obtained in one detection mode and setting a selector in the next detection mode, it is possible to improve the efficiency and accuracy of the detection operation.

In the above embodiment, a form in which recording medium edge detection and paper type detection have been combined has been described. However, the present disclosure is not limited to a combination of these two detection operations and need only be in a form in which at least two detection operations are executed in combination.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-166560, which was filed on Sep. 25, 2024 and which is hereby incorporated by reference herein in its entirety.

What is claimed is:

1. A printing apparatus comprising:
a photodetector including a plurality of light-receiving devices;
apertures through which specular reflection light and diffused reflection light, which are light from a light-emitting unit reflected by a target, pass into the photodetector;
a selector configured to select at least one light-receiving device among the plurality of light-receiving devices;
an amplifier configured to amplify a signal from a light-receiving device of the photodetector; and
one or more controllers including one or more processors and one or more memories, wherein the one or more controllers are configured to:
in accordance with a detection mode for detecting the target, perform control so as to select light-receiving devices by the selector and switch connection between the light-receiving devices selected by the selector and the amplifier.

2. The printing apparatus according to claim 1, wherein the one or more controllers further execute processing for detecting the target corresponding to the detection mode, based on a signal obtained by the amplifier amplifying signals from the light-receiving devices selected by the selector.

3. The printing apparatus according to claim 1, wherein the photodetector includes a plurality of rows in which a plurality of light-receiving devices are arranged, and
wherein the plurality of rows include a row of light-receiving devices that receive the specular reflection light and a row of light-receiving devices that receive the diffused reflection light.

4. The printing apparatus according to claim 1, wherein in a case where the detection mode is a mode for detecting at least one of a leading edge and a trailing edge of a recording medium in a conveyance direction, the one or more controllers control to cause the selector to select at least one light-receiving device positioned at a front and rear, respectively, in the conveyance direction of the recording medium.

5. The printing apparatus according to claim 3, wherein in a case where the detection mode is a mode for detecting a type of a recording medium, the one or more controllers control to cause selector to select the row of light-receiving devices that receive the specular reflection light and the row of light-receiving devices that receive the diffused reflection light.

6. The printing apparatus according to claim 2, wherein the one or more controllers further perform control such that in a case where the detection mode is a first detection mode, the selector selects a light-receiving device based on a detection result detected by processing for detecting the target corresponding to the first detection mode, and connection between the light-receiving devices selected by the selector and the amplifier is switched, then the detection mode is changed to a second detection mode, and processing for detecting the target corresponding to the second detection mode is executed.

7. The printing apparatus according to claim 6, wherein in a case where the first detection mode is a mode for detecting a type of a recording medium, and the second detection mode is a mode for detecting at least one of a leading edge and a trailing edge of the recording medium in a conveyance direction, the one or more controllers change a number of light-receiving devices to be selected by the selector depending on the type of the recording medium detected in the first detection mode.

8. The printing apparatus according to claim 1, further comprising:
a sensor unit including the light-emitting unit, the photodetector, and the apertures,
wherein the one or more controllers cause the sensor unit to scan the target.

9. The printing apparatus according to claim 1, further comprising:
a photoelectric converter configured to convert current flowing through a light-receiving device of the photodetector into a voltage value.

10. A method of controlling a printing apparatus including a photodetector including a plurality of light-receiving devices, apertures through which specular reflection light and diffused reflection light, which are light from a light-emitting unit reflected by a target, pass into the photodetector, and an amplifier configured to amplify a signal from a light-receiving device of the photodetector, the method comprising:
selecting at least one light-receiving device among the plurality of light-receiving devices;
in accordance with a detection mode for detecting the target, perform control so as to select light-receiving devices by the selector and switch connection between the light-receiving devices selected by the selector and the amplifier; and
executing processing for detecting the target corresponding to the detection mode, based on a signal obtained by the amplifier amplifying signals from the selected light-receiving devices.

11. A non-transitory computer-readable storage medium storing a program for causing a processor to execute a method of controlling a printing apparatus including a photodetector including a plurality of light-receiving devices, apertures through which specular reflection light and diffused reflection light, which are light from a light-emitting unit reflected by a target, pass into the photodetector, and an amplifier configured to amplify a signal from a light-receiving device of the photodetector, the method comprising:
selecting at least one light-receiving device among the plurality of light-receiving devices;
in accordance with a detection mode for detecting the target, perform control so as to select light-receiving devices by the selector and switch connection between the light-receiving devices selected by the selector and the amplifier; and
executing processing for detecting the target corresponding to the detection mode, based on a signal obtained by the amplifier amplifying signals from the selected light-receiving devices.
